(19) United States
(12) Patent Application Publication
(10) Pub. No.: US 2021/0391680 A1
(43) Pub. Date: Dec. 16, 2021

(54) BRUSH DEVICE FOR ELECTRICALLY CONNECTING A FIRST ELEMENT TO A SECOND ELEMENT, E-MACHINE AND DRIVE DEVICE

(71) Applicant: ZF Friedrichshafen AG, Friedrichshafen (DE)

(72) Inventors: Vyacheslav BRUSHKIVSKYY, Kressbronn am Bodensee (DE); Robert JANUSCHEVSKI, Tettnang (DE)

(21) Appl. No.: 17/286,997

(22) PCT Filed: Oct. 7, 2019
(86) PCT No.: PCT/EP2019/077032

§ 371 Date: Apr. 20, 2021

(30) Foreign Application Priority Data
Oct. 30, 2018 (DE) 10 2018 218 530.1

(51) Int. Cl. H01R 39/24; H01R 39/26; H02K 13/00; H02K 7/00

(52) U.S. Cl. CPC H01R 39/24; H01R 39/26; H01R 39/20; H02K 7/003; H02K 13/006

(57) ABSTRACT

A brush device (1) for electrically connecting a first element (2A) to a second element (2B) that can rotate relative to the first element (2A) about a rotational axis (L). In order to make electrical contact with the second element (2B), in a contact area (1A), the brush device (1) has a structure (1 B, 11B′, 1B″) that extends helically relative to the rotational axis (L). An E-machine (2) has a brush device (1) of this type, and a drive device has such an E-machine (2) for electrically driving a motor vehicle.

This application is a National Stage completion of PCT/EP2019/077032 filed Oct. 7, 2019, which claims priority from German patent application serial no. 10 2018 218 530.1 filed Oct. 30, 2018.

### FILED OF THE INVENTION

The invention relates on the one hand to a brush device for the electrical connection of a first element to a second element which can rotate relative to the first element. On the other hand the invention also relates to an e-machine with such a brush device for connecting a rotor shaft to an electric reference potential. And in addition the invention relates to a drive device for electrically driving a motor vehicle which has an e-machine of that type.

### BACKGROUND OF THE INVENTION

It is known that roller bearings can be damaged by electric voltages applied to them. It is therefore known to connect rotatably mounted components to an electrical reference potential by means of a brush device, in particular to ground, for example from US 2010/0001602 A1 (in that case denoted as a grounding ring).

DE 20 2007 008 490 U1 discloses a form of screw thread for grounding an axle of an electric motor. The electric motor has a housing in which a rotatable axle is fitted. In this case, on a circumferential surface at one end of the axle there is arranged at least one fine-threaded structure. For grounding purposes a brush device is applied laterally to the fine-threaded structure. The brush device consists of a brush, a hollow positioning body for holding the brush and a spring arranged inside the hollow positioning body. The brush is pushed by the spring in such manner that its front surface is firmly in contact with the fine-threaded structure. In that way, when the axle and the fine thread rotate, a conveying effect takes place by virtue of which the surface of the brush remains clean.

### SUMMARY OF THE INVENTION

The purpose of the present invention is to develop the prior art further.

This objective is achieved by virtue of the characteristics specified in the principal claims. Preferred embodiments emerge from the subordinate claims.

According to these, as explained to begin with, a brush device for electrically connecting a first element to a second element that can rotate relative to the first element is proposed. In addition an e-machine is proposed, which comprises a rotor shaft that can rotate about a rotational axis, and a brush device of the type concerned for connecting the rotor shaft to an electrical reference potential. Furthermore a drive device for driving a motor vehicle is proposed, which comprises such an e-machine in order to provide a drive power of the drive device. Such an e-machine transforms electrical energy into mechanical rotational movement. The e-machine is in particular a synchronous machine or an asynchronous machine. The e-machine can be an electric generator and/or motor.

The brush device serves to produce the electrical connection of the first element to the second element, wherein the second element is designed to rotate relative to the first element about a rotational axis. Thus, the second element can in particular be a rotating shaft. The first element can in particular be a housing in which the shaft is rotatably mounted, or some other component connected electrically to such a housing. The brush device has a contact area. This contact area serves to make contact with the second element. Thus, the contact area forms the actual electrical contact to the second element and at the same time allows the second element to rotate. The contact area forms a sliding contact with the second element.

The contact area of the proposed brush device has a structure that extends helically relative to the rotational axis. Thus, the structure forms at least one section of a helix along the rotational axis of the second element. Another contact area on the brush device can serve to form the electrical connection to the first element.

The helically extending structure fulfills the purpose of a conveying device for particles that make their way into the contact area with the second element. When the second contact element rotates, any such particles can be swept in an axial direction, i.e. in a direction along the rotational axis and away from the contact area. The conveying action is thus brought about by the brush device itself. Compared with the system of DE 20 2007 008 490 U1 the surface of the second element can even be smooth. Accordingly the second element can be more simply designed and can therefore be produced more inexpensively.

The particles can be worn off the brush device itself, or they can be some other form of dirt particles. For example, they can consist of lubricant emerging by leakage from a seal arranged close to the brush device. Thus, with the proposed brush device the contact area can largely be kept free from such particles.

If the second element has a preferred rotational direction, then by virtue of the rotational sense of the helical structure the particular direction can be established in which the particles should be swept. Thus, the particles can be selectively swept in the direction of a discharge opening for them.

To form the structure, the brush device can have a plurality of electrically conductive filaments projecting onto the contact area. These filaments form the actual brush of the brush device. Thus, when the brush device is used as intended the filaments provide the actual electrical connection between the two elements. Relative to the rotational axis the filaments are arranged in a helix. In particular, for this the filaments form one or more filament lines each extending helically relative to the rotational axis. It is possible but not essentially necessary for the line or the plurality of lines to be arranged (in a helix) around the whole of the circumference of the second element.

Grounding rings with electrically conductive filaments are already known as such. In the proposed brush device these are in this case arranged in a helix around the rotational axis, at least in one section, in order to produce the above-mentioned conveying action upon the particles. In that way, in a simple and inexpensive manner the structure extending helically relative to the rotational axis can be formed by filaments already known as such.

To form the structure the brush device can comprise at least one solid electric conductor that projects onto the contact area. In this case the solid conductor forms the actual brush. Thus, when the brush device is used as intended, it forms the actual electric contact between the two elements. In particular the conductor consists of graphite. In the contact area, the conductor has a surface structure that extends helically relative to the rotational axis. In particular, for this purpose one or more grooves extending helically relative to the rotational axis can be formed in the (end) face of the solid conductor that faces toward the second element. For example, the solid conductor can have a threaded section for this purpose. It is possible but not essentially necessary for the groove or plurality of grooves to be arranged (in a helix) around the whole circumference of the second element. Besides, the solid conductor can also have a projection that extends in the contact area helically relative to the rotational axis.

Grounding rings with a solid electrical conductor are already known as such. In the proposed brush device, these are in this case formed, at least in one section, with the surface structure that extends helically around the rotational axis in order to achieve the aforesaid conveying action for the particles. In this way too it is simply and inexpensively possible to form the structure that extends helically relative to the rotational axis, by means of a solid conductor.

To form the structure the brush device can comprise at least one lip-shaped electric conductor that projects onto the contact area, which conductor is arranged helically relative to the rotational axis. In this case the lip-shaped conductor forms the actual brush. Thus, when the brush device is used as intended the lip-shaped conductor provides the actual electrical connection between the two elements. It is formed in particular by a flexible lip which lies flat against the second element, and thereby forms the electrical connection, and is arranged at least in one section helically relative to the rotational axis in order to achieve the above-mentioned conveying action for the particles. In this way too it is simply and inexpensively possible to form the structure that extends helically relative to the rotational axis.

The helically extending structure can either be of single-pitch or multiple-pitch design. In a single-pitch structure, for example only a single line of conductive filaments or only a single groove in the solid conductor or only a single conductive lip is provided, which extends in a helix about the rotational axis. This is comparable to a thread with only one thread pitch. In a multiple-pitch structure, for example several lines of conductive filaments, or several grooves in the solid conductor, or several conductive lips are provided, which extend close to one another helically around the rotational axis. This is comparable to a thread with two or more thread pitches. In that way both good electrical conductivity and also an efficient conveying action can be achieved.

The e-machine proposed has a rotor shaft that can rotate about a rotational axis. The rotor shaft is in particular connected to a rotor of the e-machine and this can also include the case when the rotor and the rotor shaft are made integrally, as one piece. The rotor and thus also the rotor axis is in particular rotatable relative to a stator of the e-machine fixed on the housing. The e-machine has a brush device for connecting the rotor shaft to an electrical reference potential. This reference potential is in particular an electrical ground or ground potential. The brush device of the proposed e-machine is in the form of the proposed brush device. Thus, the rotor shaft can be electrically grounded or connected to ground in a simple manner. In this case the second element, which is acted upon by the brush device, is the rotor shaft. The first element, from which the action of the brush device derives, is the ground or ground, or some other component to which the latter is electrically connected and on which the brush device is mounted in an electrically conductive manner. This is in particular a housing of the e-machine.

Preferably, the e-machine has an inside space in which the rotor connected to the rotor shaft is rotatably arranged. The rotor shaft then projects out of the inside space via a shaft seal. The shaft seal seals the inside space of the e-machine, against the rotor shaft, relative to the outside. The shaft seal is in particular in the form of a radial shaft seal or a labyrinth seal. The brush device is arranged close to the shaft seal outside the inside space. Thus, the brush device is positioned outside the sealed-off inside space of the e-machine a relatively short distance away from the shaft seal. Thus, the brush device can be attached to the e-machine and the rotor shaft in a simple manner, from the outside.

The proposed drive device serves to drive a motor vehicle electrically. Accordingly, the drive device comprises an e-machine for the provision of drive power for the motor vehicle. In particular the drive device can be in the form of a drive module and, for example, it can be designed for fitting to a driven axle of the motor vehicle. The e-machine of the proposed drive device is formed by the proposed e-machine, i.e. one that comprises the proposed brush device.

### BRIEF DESCRIPTION OF THE DRAWINGS

Below, the invention is explained in greater detail with reference to figures from which further preferred embodiments and features of the invention can be seen. The figures show, in schematic form:

FIG. 1: A three-dimensional view of a proposed brush device,

FIG. 2: A longitudinal section through a proposed e-machine with a brush device.

### DETAILED DESCRIPTION OF THE PREFERRED EMBODIMENTS

In the figures, the same or at least functionally identical components or elements are given the same indexes.

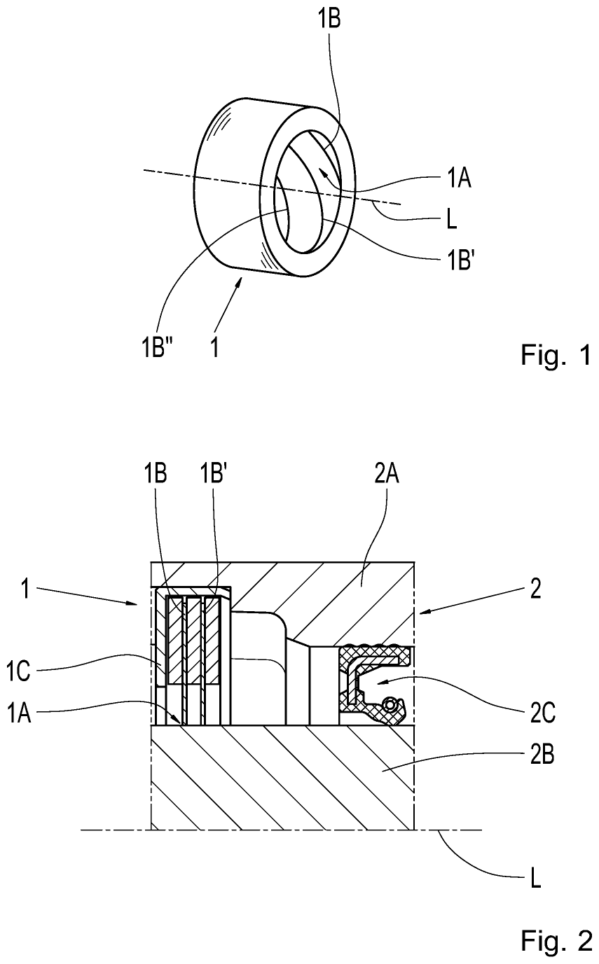

The brush device 1 according to FIG. 1 serves for the electrical connection of a first element, such as a housing (not shown), to a second element such as a rotatable shaft that can rotate relative to the first element. A rotational axis L of the second element extends through the center of the brush device 1. The brush device is designed, for example, to be fitted in or on an e-machine in order to connect a rotor shaft of the e-machine electrically to a housing of the e-machine and thereby to form a ground or grounding connection for the rotor shaft. An example of this is shown in FIG. 2.

According to FIG. 1, in a radially inner area 1A the brush device 1 has a structure that extends helically relative to the rotational axis. This structure is indicated by the helical lines 1B, 1B′ and 1B″. As shown, the structure can comprise several pitches (lines 1B, 1B′ and 1B″). However, the structure can also be of single-pitch design (only one of the lines 1B, 1B′ or 1B″). The structure can extend completely around the rotational axis L once or several times. However, the structure can also be formed of only one helical section.

The structure 1B, 1B′, 1B″ serves to form a sliding contact with the second element. If the brush device 1 is mounted on the second element and the first element is brought into electrical contact with the structure 11B, 11B′, 11B″ in the contact area, the electrical connection between the first and second elements is established.

The structure can be formed in that at least in a section along the line 1B, 1B′ or 1B″ shown in FIG. 1, a row of electrically conductive filaments that project as far as the contact area 1A are provided as the brush. Alternatively, the structure can be formed in that one or more solid electrical conductors projecting as far as the contact area 1A is/are provided as brushes, which at least in a section have a surface structure, in particular such as one or more grooves, that extends along the line 1B, 1B′ or 1B″ shown in FIG. 1. Alternatively, the structure can be formed in that at least in a section along the line 1B, 1B′ or 1B″ shown in FIG. 1, a lip-shaped electrical conductor projecting as far as the contact area 1A is provided.

The second element is then positioned with a surface in contact with the structure. That surface can be smooth. During rotation, the helical shape of the structure gives rise to a conveying action which sweeps particles in the contact area 1A away from the brush device (see the shape of the lines 1B, 11B′, 1B″). Depending on the rotational direction of the second element and the twist direction of the structure, in FIG. 1 the particles are swept away from the brush device 1 either forward or rearward.

FIG. 2 shows part of a longitudinal section through an e-machine 2. The figure shows part of a housing 2A of the e-machine 2 and part of a rotor shaft 2B of the e-machine 2 which is mounted to rotate in the housing. Also to be seen is a shaft seal 2C which, in the area of the rotor shaft 2B, seals an inside of the e-machine 2 relative to the outside. The shaft seal 2C is fixed in the housing 2A. The rotor shaft 2B is connected to a rotor of the e-machine 2 and can therefore be driven in rotation.

Close to the shaft seal 2C, on the outside of the e-machine 2 there is a brush device 1. This comprises the structure that extends helically relative to the rotational axis L of the rotor shaft as shown in FIG. 1 (indexed 1B, 1B′) as the actual brush. In FIG. 2 this structure is formed, for example, by two electrically conductive lips or two rows of electrically conductive filaments. As can be seen in FIG. 2, in a radially outer area these are held in a holder 1C of the brush device 1 in which they are fixed. Starting from there they project radially inward as far as the contact area 1A of the brush device 1, where they make contact with the rotor shaft 2B. The holder 1C of the brush device 1 is also electrically conductive. For example, it is made of sheet iron. Thus, there is an electrical connection between the rotor shaft 2B and the housing 2A which results in an electric potential equalization between them. Correspondingly, a connection of the rotor shaft 2B to an electric ground or an electric grounding can be formed.

By virtue of the helical structure of the brush device 1 relative to the rotational axis L of the rotor shaft, when the rotor shaft 2B rotates particles are swept out of the contact area 1A. Such particles can be produced by wear of the contact area 1A itself, or they can be in the form of lubricant particles from a leak in the nearby shaft seal 2C.

In the area axially in front of and/or behind the brush device 1, a scraper edge can be provided on the rotor shaft 2B. This facilitates the clearing away of particles from the rotor shaft 2B after they have been swept out of the contact area 1A. Likewise, in the area axially in front of and/or behind the brush device 1 a discharge opening can be provided in the housing 2A. This facilitates the complete clearing away of such particles.

### INDEXES

1 Brush device
1A Contact area
1B Line; structure
1B′ Line; structure
1B″ Line; structure
1C Holder
2 E-machine
2A Housing
2B Rotor shaft
2C Shaft seal

1-8. (canceled)

9. A brush device (1) for electrically connecting a first element (2A) to a second element (2B) that is rotatable relative to the first element (2A) about a rotational axis (L),
in a contact area (1A) for forming an electrical contact with the second element (2B), the brush device (1) having a structure (1B, 1B′, 1B″) that extends helically relative to the rotational axis (L).

10. The brush device (1) according to claim 9, wherein the structure (1B, 1B′, 1B″) is formed by a plurality of electrically conductive filaments projecting to the contact area (1A), and the filaments are arranged helically relative to the rotational axis (L).

11. The brush device (1) according to claim 9, wherein the structure (1B, 1B′, 1B″) is formed by at least one solid electrical conductor that projects to the contact area (1A) such that, in the contact area, the conductor has a surface structure that extends helically relative to the rotational axis (L).

12. The brush device (1) according to claim 9, wherein the structure (1B, 1B′, 1B″) is formed by at least one lip-shaped electrical conductor that projects to the contact area (1A), and the conductor is arranged helically relative to the rotational axis (L).

13. The brush device (1) according to claim 9, wherein the helically extending structure (1B, 1B′, 1B″) is of a single-pitch or a multiple-pitch design.

14. An E-machine (2) with a rotor shaft (2B) that can rotate about a rotational axis (L) and with a brush device (1) for electrically connecting the rotor shaft (2B) to an electric reference potential (2A), wherein the brush device (1) is designed according to claim 9.

15. The E-machine (2) according to claim 14, wherein the E-machine (2) has an inside space in which a rotor, connected to the rotor shaft (2B), is rotatably arranged,
the rotor shaft (2B), via a shaft seal (2C), projects out of the inside space,
the brush device (1) is arranged outside the inside space and adjacent to the shaft seal (2C).

16. A drive device for electrically driving a motor vehicle, the drive device comprising an E-machine (2) for provision of a drive power of the drive device,
wherein the E-machine (2) is designed according to claim 14.
